(19) United States
(12) Patent Application Publication
(10) Pub. No.: US 2011/0137618 A1
(43) Pub. Date: Jun. 9, 2011

(54) GEOTECHNICAL HORIZONTAL DIRECTIONAL DRILLING

(76) Inventors: John Walter Fluharty, II, Naples, FL (US); Richard Neil Smith, Spring, TX (US); Ronald G. Halderman, Billings, MT (US)

(21) Appl. No.: 12/961,482

(22) Filed: Dec. 6, 2010

Related U.S. Application Data
(60) Provisional application No. 61/266,869, filed on Dec. 4, 2009.

(51) Int. Cl. G06F 17/50; G06F 19/00; G01V 9/00; E21B 49/00; G06Q 99/00

(52) U.S. Cl. 703/1; 702/6; 702/11; 175/50; 705/400

(57) ABSTRACT

A system and method for designing and constructing an optimized underground crossing through the earth is provided. The underground crossing allows one or more delivery line to pass through the earth. The method involves forming an investigation bore path along a preliminary path of the underground crossing and collecting geological data along the investigation bore path. The method involves determining a selected bore path for the underground crossing and finalizing a design for the construction of the underground crossing. The finalized design is based upon the collected geological data. The method involves obtaining one or more permits for the underground crossing based on the finalized design.

### CROSS-REFERENCE TO RELATED APPLICATIONS

This application claims the benefit of U.S. Provisional Application No. 61/266,869, filed Dec. 4, 2009.

### BACKGROUND

The invention relates to techniques for performing horizontal directional drilling. More particularly, the invention relates to techniques for optimizing the construction of an underground crossing for one or more delivery lines.

Pipelines, utility lines, and/or delivery lines, may be constructed to transport fluids, data, and/or energy from one location to another. During the construction of a pipeline and/or a utility line it may be necessary to bury the pipeline and/or utility line underground. Placing the pipeline and/or utility line underground may be done to avoid obstructions, and/or for aesthetic reasons. To locate the pipeline underground, the soil may be excavated to form a trench. The pipeline may then be constructed in the trench. The pipeline may then be buried.

Further, horizontal directional drilling has been used to install a pipeline underground. Horizontal directional drilling may be a complex process. Currently, for the construction of a horizontal directional drilling pipeline project, no surveying is done through the underground crossing prior to beginning construction on the project. Therefore, there are many assumptions taken prior to the kick off of the construction project. These assumptions may cause problems in estimating the schedule, estimating the cost, obtaining the permits, and understanding the feasibility of the project.

### SUMMARY

A disclosure relating to a method for designing and constructing an underground crossing through the earth is provided. The underground crossing allows one or more delivery lines to pass through the earth. The method includes forming an investigation bore path along a preliminary path of the underground crossing and collecting geological data along the investigation bore path. The method includes determining a selected bore path for the underground crossing and finalizing a design for the construction of the underground crossing. The finalized design is based upon the collected geological data. The method includes obtaining one or more permits for the underground crossing based on the finalized design.

The disclosure further relates to a method for forming an underground crossing through the earth at a worksite. The underground crossing allows one or more delivery lines to pass through the earth. The method includes determining a preliminary path of the underground crossing and forming an investigation bore path along the preliminary path. The method includes collecting geological data along the investigation bore path and determining a selected bore path for the underground crossing. The method further includes finalizing the design of the underground crossing based on the collected geological data and forming the underground crossing along the selected bore path.

The disclosure further relates to a system for forming a bore path through the earth. The bore path is for an underground crossing having of one or more delivery lines. The system has a drilling rig and a drilling tool. The drilling tool may be conveyed into the earth by the drilling rig for forming an investigation bore path in the earth prior to forming the bore path. The system may have a data collection system for collecting geological information regarding the investigation bore path prior to constructing the bore path. The collected geological information from the investigation bore path may be used to determine a selected path for the bore path.

### BRIEF DESCRIPTION OF THE DRAWINGS

The embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 is a schematic view of a worksite having an optimized underground crossing according to an embodiment.

FIG. 2 is a schematic view of the worksite during a data collection phase according to an embodiment.

FIG. 3 is a schematic view of the worksite during the data collection phase according to an embodiment.

FIG. 4 is a schematic view of the worksite during the data collection phase according to an alternative embodiment.

FIG. 5 is a diagram depicting a log according to an embodiment.

FIG. 6 is a diagram depicting the log according to an alternative embodiment.

FIG. 7 is a flowchart depicting a method of forming the optimized underground crossing.

### DESCRIPTION OF EMBODIMENT(S)

The description that follows comprises exemplary apparatus, methods, techniques, and instruction sequences that embody techniques of the inventive subject matter. However, it is understood that the described embodiments may be practiced without these specific details.

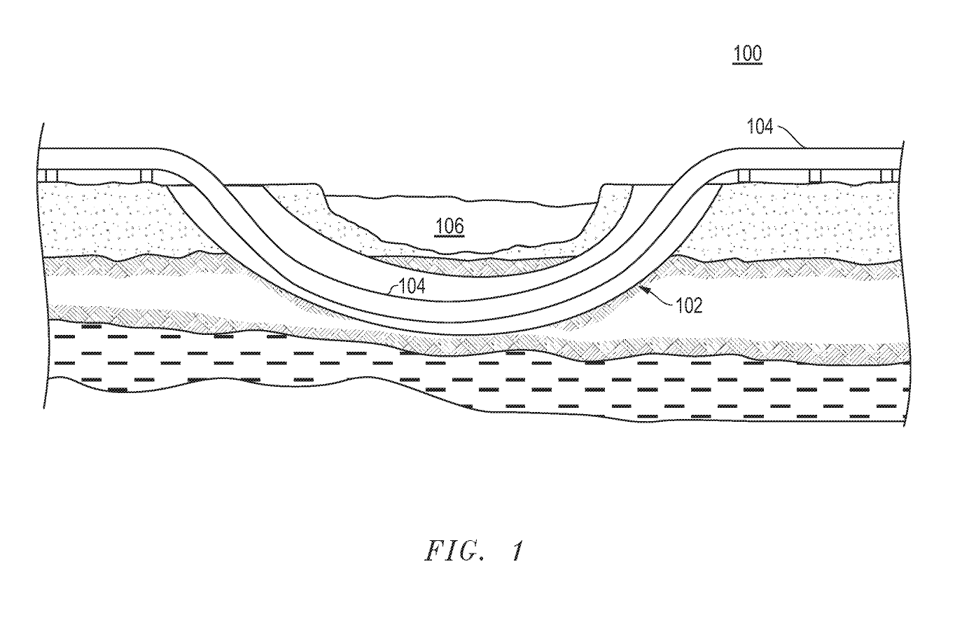

FIG. 1 is a schematic view of a worksite 100 having an optimized underground crossing 102. The optimized underground crossing 102, or the underground crossing 102, may be configured to allow one or more delivery lines 104 to pass through the underground crossing. The delivery lines 104 may pass through the underground crossing for any suitable reason including, but not limited to, avoiding an obstruction 106, for aesthetic reasons, and the like. As shown, the obstruction 106 is a lake; however, the obstruction 106 may be any suitable obstruction that needs to be avoided including, but not limited to, a structure, a body of water, an arctic work hazard, a roadway, a shore, railroad tracks, a pipeline, and the like.

The optimized underground crossing 102 may be formed by first forming an investigation bore path substantially along the preliminary path of the optimized underground crossing 102. Data regarding the optimized underground crossing 102 may be collected during the forming of the investigation bore path. A geological investigation may then be performed from data collected while forming the investigation bore path. The data collected during the geological investigation is then used to design and form the optimized underground crossing 102, as will be described in more detail below. The optimized underground crossing 102, the delivery lines 104 and/or the investigation bore path may be referred to as horizontal paths or bores. The horizontal paths may be partially horizontal under the earth and/or be offset at an angle from a vertical plane.

The delivery line 104 shown in FIG. 1 is a pipeline for transporting fluids. The fluids may be any suitable fluids including, but not limited to, crude oil, gas, LNG, hydrocarbons, water, air and the like. Although, the delivery lines 104 is shown as a pipeline it should be appreciated that the delivery lines 104 may be any suitable delivery line, or system of delivery lines, such as a utility line, a communication line, a fiber optic line, a telephone line, and the like.

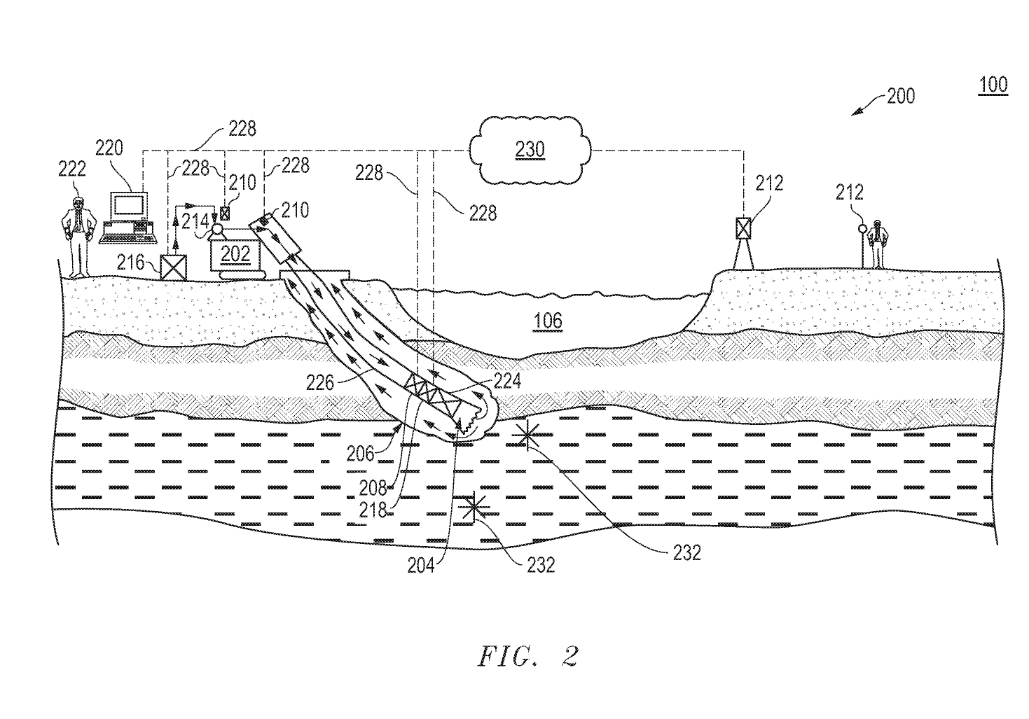

FIG. 2 shows the worksite 100 having a data collection system 200 for collecting preliminary data regarding the worksite 100. The preliminary data may be collected prior to completion of the optimized underground crossing 102 (as shown in FIG. 1). The data collection system 200 may be any equipment, devices, and/or personnel used during a data collection phase of the construction of the optimized underground crossing 102. The data collection system 200 may have a drilling rig 202 for motivating a drilling tool 204 through the earth to form one or more investigation bore paths 206. The data collection system 200 may further include, but is not limited to, one or more downhole sensors 208, one or more surface sensors 210, survey equipment 212, a pumping system 214, a mud mixing system 216, one or more downhole survey tools 218, one or more computer systems 220 and/or one or more worksite personnel 222.

Prior to forming the one or more investigation bore paths 206 a site visit and/or a land survey may be performed at the surface of the worksite 100. The site visit and/or land survey may be done to determine preliminary locations for entry points under ground for the optimized underground crossing 102. Further, the site visit and/or land survey may be performed to determine locations of potential obstructions, existing pipe, and existing services. The site visit and/or land survey may discover what potential problems may arise while performing the data collection phase and constructing the optimized underground crossing 102. The worksite personnel 222 may use the survey equipment 212 to survey the surface at the worksite 100. The site visit and/or land survey may determine the tools necessary to execute the data collection phase. Further, the site visit and/or land survey may allow the personnel to determine a preliminary design prior to forming the investigation bore paths 206.

The preliminary design of a potential crossing path may be designed based on the site visit and/or the land survey. In addition to the site visit and/or land survey, information about the worksite 100 may be obtained from existing geotechnical data including, but not limited to, geological maps, department of transportation records, water well data, previous pipeline projects, previous underground projects, and the like. The preliminary design may determine the potential crossing path to be used for a geotechnical investigation of the potential crossing path. Further, the preliminary design may determine the types of wellbores and/or underground investigation procedures to be performed during the project. With the potential crossing path from the preliminary design determined, an investigation bore path 206 may be formed along the potential crossing path.

The investigation bore path 206 may be formed by the drilling rig 202 motivating the drilling tool 204 into the earth. The drilling rig 202 may be any suitable drilling rig for forming the one or more investigation bore paths 206 including, but not limited to, a horizontal directional drilling (HDD) rig, a slant drilling rig, and the like.

The drilling tool 204, as shown, is either a drill bit that is rotated with a mud motor 224 located proximate the drilling tool 204 or a jet bit. The mud motor 224 may rotate the drilling tool 204 when drilling mud and/or fluids are pumped down a drill string 226, or drill shaft. The drilling mud may also be used to lubricate the drilling tool 204 during drilling and to wash away the drill cuttings. Although the drilling tool 204 is described as a drill bit being rotated by a mud motor 224 any suitable method of rotating the drilling tool 204 may be used including, but not limited to, a downhole motor, a top drive, a surface rotation device, and the like. The drilling tool 204 may further be a steerable drill assembly in order to guide the drilling tool 204 along the investigation bore path 206. For example the worksite 100 may use TENSO, GPS, and/or PARATRAC to assist in steering the drilling tool 204. Further, any suitable steerable drill assembly, and/or drilling system, may be used.

During the forming of the investigation bore path 206 a data collection process may be performed to determine one or more geological parameters of the worksite 100. The geological parameters may be any suitable geological data and/or information gathered and/or determined about the worksite 100 during the forming of the investigation bore path 206. The downhole survey tool 218, as shown in FIG. 2, is a survey while drilling tool, that may survey the investigation bore path 206 while drilling. The downhole survey tool 218 may communicate with the surface via the one or more communication links 228. The communication links 228 between the downhole survey tool 218 and the surface may be hardwired to the downhole survey tool 218. Further, the communication links 228 from the downhole survey tool 218 and the surface may be any suitable communication connection including, but not limited to, wireless connections, a wire line, hard wired, an acoustic signal, telemetry, and the like. The communication links 228 may be used about the worksite 100 to allow for communications between the downhole survey tool 218, the one or more downhole sensors 208, the surface sensors 210, the survey equipment 212, the mud mixing system 216, the one or more computer systems 220, and/or a communication network 230. The communications links 228 and/or the network 230 may further send data to an offsite location to allow for worksite design, and/or real time monitoring of the work performed at the worksite 100.

The one or more downhole sensors 208 may collect data regarding the investigation bore path 206 during the forming and/or analysis of the investigation bore path 206. The one or more downhole sensors 208 may be any suitable sensors for collecting downhole data. For example, the one or more downhole sensors 208 may include, but are not limited to, a pressure sensor, a flow meter, a temperature sensor, a weight on bit sensor, a strain gauge, a gyroscope (for three axis mapping), an annular pressure monitor, a rate of penetration monitor, torque sensor, and the like. The one or more downhole sensors 208 may send the collected data to the one or more computer systems 220, and/or any other suitable location.

The one or more surface sensors 210 may collect data regarding the investigation bore path 206 from the surface during the formation and/or analysis of the investigation bore path 206. The one or more surface sensors 210 may be any suitable sensors for collecting data regarding the worksite 100. For example, the one or more surface sensors 210 may include, but are not limited to, surface pressure sensor, drilling mud pressure sensor, torque sensor, pump flow rate sensor, push/pull pressure on the drill string 226, and the like. The one or more surface sensors 210 may send the collected data to the one or more computer systems 220 and/or any other suitable location.

The mud mixing system 216 may be any suitable system and/or device for preparing drilling fluids and handling the drilling mud recovered from the investigation bore path 206. For example, the mud mixing system 216 may include, but is not limited to, a 250 gpm mud/cleaning system. The mud mixing system 216 may include one or more strainers to collect the drill cuttings from the investigation bore path 206. The mud mixing system 216 may further have any number of sensors for analyzing the drilling mud collected from the investigation bore path 206, including any sensors described herein. The sensors may send data to the one or more computer systems 220 for analysis.

The drill cuttings and/or the drilling mud may further be analyzed by the worksite personnel 222. For example, the worksite personnel may be a geologist, or a geotechnical field hand. The personnel 222 may analyze pit volume and the drill cuttings to determine what type of soil, rock, and/or fluid formations may exist along the path of the investigation bore path 206. The personnel 222 may collect the data from the mud mixing system 216, and/or any of the systems in the data collection system 200 and enter them into the computer system 220 for analysis. The data collected and entered into the computer system 220 may be analyzed and compiled into a horizontal drilling geotechnical mud log and/or a drill log, as will be described in more detail below.

During the forming of the investigation bore path 206 any number of subsurface hazards 232, or underground hazards, may be encountered. The subsurface hazards 232 may be any hazard including, but not limited to a thief zone, a structure, a pipe, a natural obstruction, any obstruction described herein, and the like. The thief zone is a subsurface zone of high permeability and/or porosity that may be referred to as lost circulation zones, frac outs and/or lost zones. The thief zone may take and/or absorb drilling mud from the wellbore being formed. During drilling if the drilling tool 204 may encounter a thief zone, the drilling mud, or a substantial portion of the drilling mud, may be lost to the thief zone and therefore not circulated back to the surface. The loss in the drilling mud may result in a loss of circulation of the drilling mud. The loss of circulation may become a serious impediment to continued drilling as the loss of annular pressure to the thief zone may cause the drill string 226 to stick to the wall of the bore hole or the loss of the integrity of the bore hole. The sticking may result in a stuck drill string 226. Encountering any of these subsurface hazards 232 during the formation of an underground crossing may be time consuming and costly to the project. For example, a new path for the underground crossing may have to be formed thereby requiring new design work and new permits to be obtained.

In the event of fluid loss during the forming of any of the one or more investigation bore paths 206, the drilling crew, or personnel 222, may stop the drilling operation and determine if the loss of fluid is visible. If the loss of fluid is visible, the drilling crew may retract the drilling tool 204. The personnel 222 may then determine a new preliminary path and begin forming a new investigation bore path along the new preliminary path.

The subsurface hazards 232 may be detected by the data collection system 200 during the formation of the investigation bore path 206 and/or during the data collection phase of the project. In the event a subsurface hazard 232 is detected during the data collection phase, more investigation bore paths 206 may be formed along potential crossing paths as described above. The data collection system 200 may collect data for each of the investigation bore paths 206 formed during the data collection phase of the project.

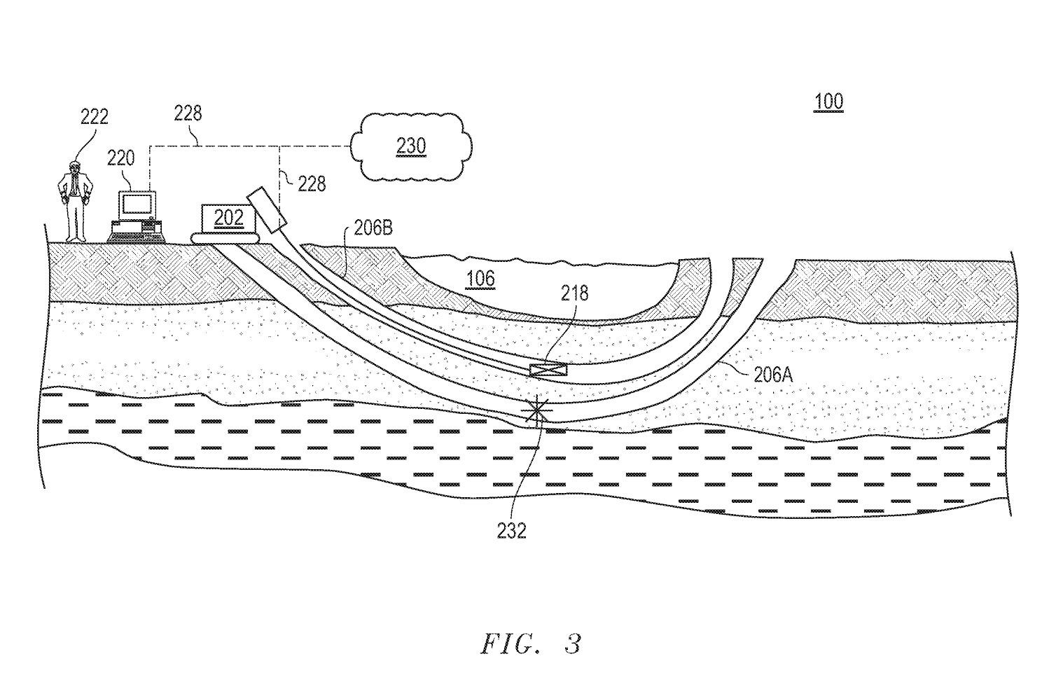

FIG. 3 is a schematic view of the worksite 100 having multiple investigation bore paths 206 formed. One or more of the investigation bore paths 206 may be surveyed using a downhole survey tool 218. The downhole survey tool may be used in addition to data collected during drilling. Further, core samples, or core boring, may be performed on the investigation bore paths 206. The core boring may yield a cylindrical shaped rock or core for analysis from the path of the investigation bore path 206. The core may be sent to a laboratory for analysis to determine the rock properties along each of the investigation bore paths 206. The core samples may yield rock properties including, but not limited to, compressive strength, silica content, rock make up, and the like.

Any of the downhole survey tools 218 described herein may be operated by personnel and may include, but are not limited to, a logging truck. During drilling, the soil and rock type and properties and/or the rate of penetration may be determined. During the wireline logging, after the investigation bore path 206 has been formed, soil and/or rock properties may be determined.

In addition to the systems and devices described for collecting data with the data collection system 200, the data collection system 200 may further include, but is not limited to, an electronic data recorder, a gamma ray neutron, a magnetic steering tool, a reservoir performance monitor, a reservoir saturation tool, seismic data collection methods, a ground penetration radar, a reservoir performance monitor, a reservoir saturation tool, a gyroscope for XYZ monitoring, an annular pressure monitoring system, and the like. Any of the data collection systems and devices described herein may determine, but is not limited to, drill rate, RPM, weight on the bit, torque, temperature, pit gain or loss, identify underground formations, silica percentages, mineralogy, rock and/or soil properties, as built path location, pressure downhole, soil investigation around the investigation bore path (for example up to a certain radius around the investigation bore path), and the like.

As shown in FIG. 3, at least one of the investigation bore paths 206A may have encountered the subsurface hazard 232. In the event the investigation bore path 206 encounters the subsurface hazard 232, additional investigation bore paths 206B may be formed for further analysis during the data collection phase. Several additional investigation bore paths 206B may be formed in order to collect more data and fully understand the geology of the worksite 100. Therefore, multiple investigation bore holes 206B may pass under the earth without encountering the subsurface hazards 232.

During the data collection phase any number of geotechnical parameters may be determined for the earth along the investigation bore paths 206 and the worksite 100. The geotechnical parameters may include, but are not limited to, porosity, permeability, density, plasticity, silica content, compressive strength, rock mechanical properties, and the like.

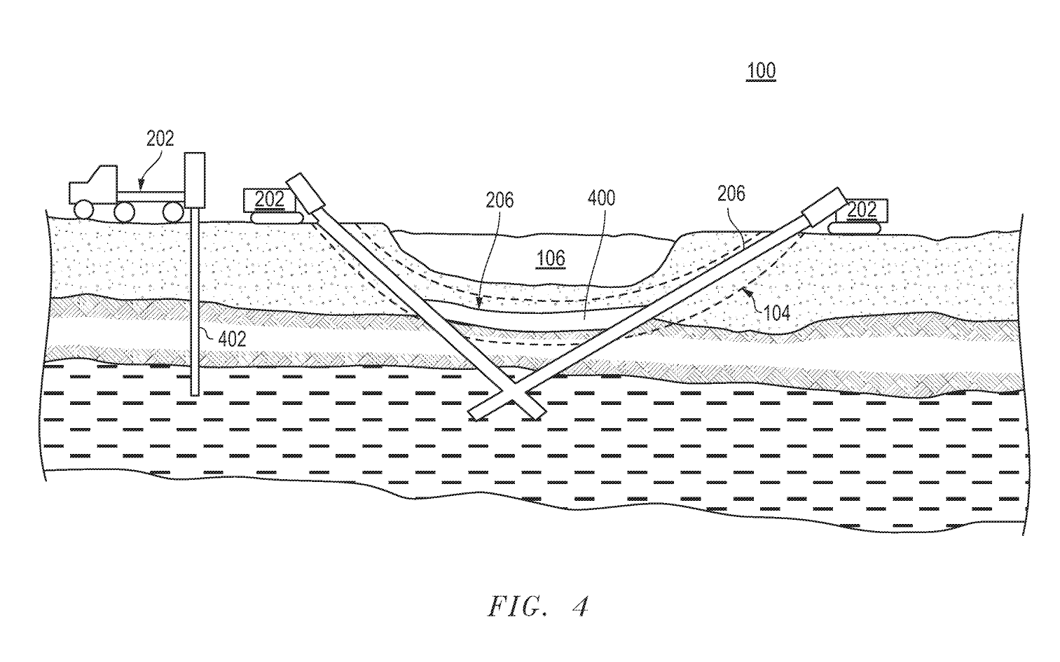

FIG. 4 is a schematic view of the worksite 100 showing an additional method for forming the investigation bore paths 206 and/or the optimized underground crossing 102. As shown, there may be multiple drilling rigs 202 which drill multiple horizontal wells, or wells at a slant into the earth's surface. The drilling rigs 202 may drill at any suitable angle into the earth's surface, for example at a 15° angle or less. Further, the drilling rigs 202 may drill at angles greater than 15°. The bore holes formed by the multiple drilling rigs 202 may intersect underground, and/or come substantially close to one another. An investigation bridge 400 may then be formed between the multiple slanted bore holes along the path of the investigation bore path 206. During the forming of the investigation bore path 206, shown in FIG. 4, any of the methods and/or devices for data collection may be used to collect data.

In addition to the investigation bore paths 206 described above one or more vertical investigation bore holes 402 may be formed at the worksite 100. During the forming of the vertical investigation bore holes 402 any of the data collection methods and/or devices described above may be used to collect data. The vertical investigation bore holes 402 may provide additional information about the worksite 100.

The data collected by the data collection system 200 may be used to form one or more logs. The logs may be representations, and/or comparisons, of each of the investigation bore paths 206 (as shown in FIG. 2-4). Further the logs may represent any conditions of the worksite 100. The logs may quantify any number of parameters of each of the investigation bore holes 206. The logs may be any suitable logs including, but not limited to, drilling logs, horizontal drilling geotechnical mud logs, pressure logs, rate of penetration logs, directional logs, and the like.

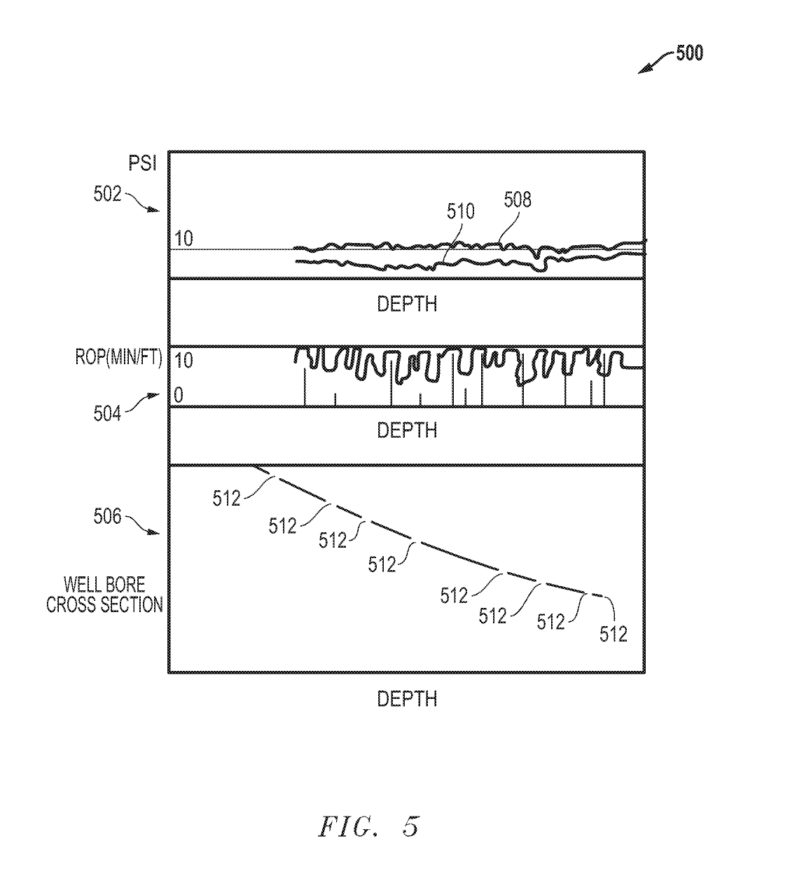

FIG. 5 is a diagram depicting a log 500 made from data collected by the data collection system 200, according to an embodiment. The log 500, as shown, has a pressure log 502, a rate of penetration log 504, and a wellbore cross section log 506. The pressure log 502 may include, but is not limited to annular pressure 508 and a pressure at the surface 510. The rate of penetration log 504 may represent the rate the drilling tool cuts through the earth along the length of the entire investigation bore hole 206.

The wellbore cross section log 506 may represent a scale profile of the investigation bore paths 206 as drilled and displayed in two dimensions. One or more survey points (optionally combined with information) 512 along the investigation bore path 206 may be represented on the wellbore cross section log 506. The wellbore cross section log 506 may provide information regarding the investigation bore path 206 rock and/or soil penetrated, subsurface hazards encountered, soil and/or rock characteristics, the bore hole path (e.g. data), any geology parameters described herein, and the like. The rock and/or soil characteristics may be any suitable parameters of the rock and/or soil including, but not limited to, porosity, permeability, density, plasticity, silica content, compressive strength, rock mechanical properties, and the like.

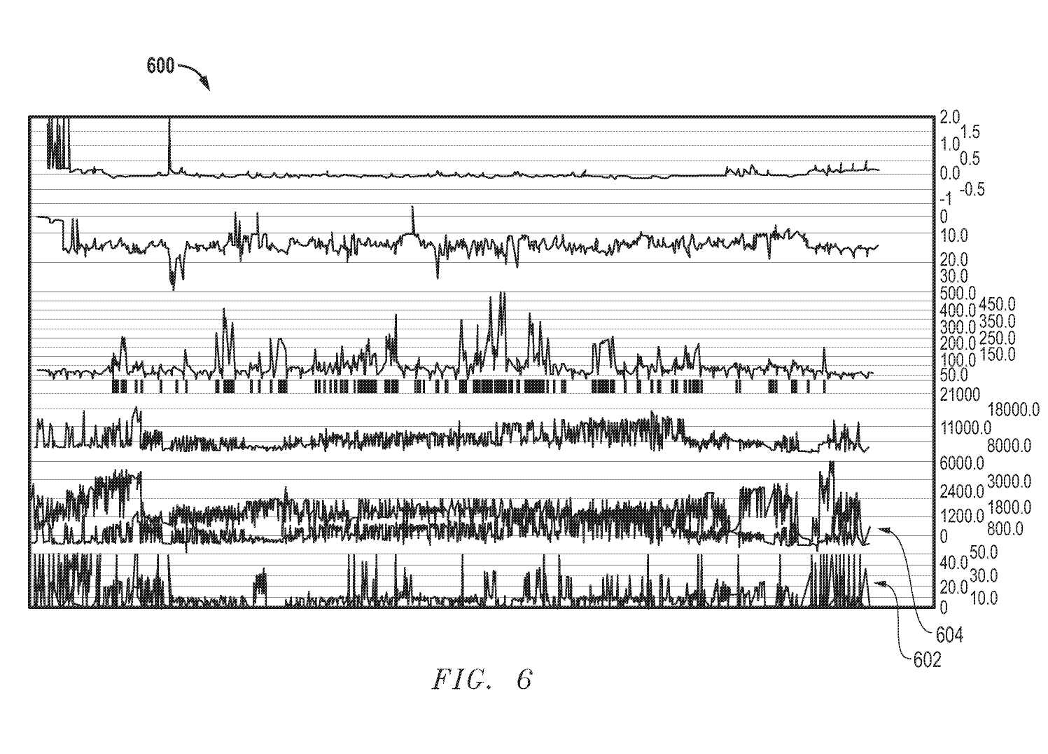

FIG. 6 is a diagram depicting a log 600 made from data collected by the data collection system 200, according to an alternative or additional embodiment. The log 600, as shown, has a rate of penetration log 602 and a thrust force and/or torque pressure log 604. The log 600 may further display data (or incorporate information 512 of FIG. 5) regarding the subsurface porosity, the sigma formation, gamma ray data, wellbore cross section, and the like.

The logs and/or the data collected by the data collection system 200 may be compared in order to determine the best route for forming the optimized underground crossing 102 (as shown in FIG. 1). For example, several investigation bore paths 206 (as shown in FIGS. 2-4) may be compared to determine the most feasible and cost efficient path for forming the optimized underground crossing 102. Several factors may be taken into account from the data collection phase when determining the best path for the optimized underground crossing 102. For example, the cost of construction of each route based on the underground conditions may be taken into account, the time required to construct each route may be taken into account, the avoidance of the underground hazards, and the like.

Once the path is selected for the optimized underground crossing 102, the final design of the optimized underground crossing 102 may be completed. During the final design phase a scope of work may determined for the project, the project may be scheduled, a design staff may execute the planning phase of the project, a construction schedule and staff may be accounted for, and the like. Because the path of the optimized underground crossing 102 is based on an in depth geotechnical investigation, the understanding of the projects scope, cost, and schedule will be known prior to construction. Due to the in depth geological knowledge collected along the selected path, a very accurate cost, scope of work, and schedule may be prepared for the project prior to permitting and construction. During the construction of the optimized underground crossing, the forming of the optimized underground crossing, or the horizontal directional drilling, may be the critical path for the project. Therefore, understanding the full scope of the subsurface hazards, and geological conditions along the selected path may minimize the time spent forming the optimized underground crossing. This may greatly decrease the cost associated with the construction of the optimized underground crossing.

During the final design one or more construction parameters may be determined and optimized for the construction of the optimized underground crossing. For example, the pump pressures, the drilling parameters, the drilling rig type, the drilling tool type, the drilling mud type and/or the reamer selection may be determined and/or optimized to match the requirements of the actual rock and/or soil characteristics along the selected path. During the construction of the optimized underground crossing, the forming of the optimized underground crossing, or the horizontal directional drilling, may be the critical path for the project. Therefore, understanding the full scope of the subsurface hazards, and geological conditions along the selected path may minimize the time spent forming the optimized underground crossing. This may greatly decrease the cost associated with the construction of the optimized underground crossing.

The necessary permits for the optimized underground crossing 102 project may be obtained once the path, or route, of the optimized underground crossing 102 is determined from the geotechnical investigation. Further, the permits may be obtained after or simultaneously with the finalized design of the project. The permits may require a detailed description of the planned route of the optimized underground crossing. If no detailed geotechnical investigation had been conducted, the permit route would be based on guess work from the earth's surface. If the route permitted without the geotechnical investigation were too costly or encountered a subsurface hazard, an additional permit may need to be secured for a second route. Therefore, knowing the optimal route, from the data collection phase, prior to construction may save substantial time by only needing to obtain one permit.

Once the permits are obtained and the design is finalized, the pre-construction phase of the project may begin. Selection of a construction contractor may be completed during this phase. There may be one or more site visits by a number of selected contractors. Proposals for the construction of the optimized underground crossing may be submitted based on the finalized design with a detailed knowledge of the subsurface geological conditions. Having the geological knowledge of the worksite 100 prior to the proposal may substantially reduce risks for the construction project. Based on the proposals, the contractor may be selected.

With the contractor selected, the equipment and personnel necessary to form the optimized underground crossing 102 may be mobilized to the worksite 100. The equipment may include, but is not limited to the drilling rig 202 and the drilling tool 204, as shown in FIG. 2. The construction of the optimized underground crossing 102 may begin with a survey crossing along the selected path from the finalized design phase of the project. The survey crossing may simply be a last investigation pass along the selected path prior to forming a pilot hole.

The pilot hole may be formed by extending and/or completing the investigation bore hole along the selected path. During the forming of the pilot hole, As-Drilled plan and profile drawings may be prepared for use in the construction bid package. A drill pipe may be left in the pilot hole, for example a 2 ⅞″ drill pipe, for use as a guide for washing over larger construction drill pipe.

The pilot hole may then be formed using the drilling rig 202 and the drilling tool 204. The pilot hole is a guide hole along the selected path to help form the optimized underground crossing 102. Further, any other suitable drilling rig and/or drilling tool may be used to form the pilot hole. Because the pilot hole may be formed along the path of one of the selected investigation bore holes 206, the pilot hole may be easier to form, than a pilot hole formed in un-disturbed earth. Once the pilot hole is formed along the selected path, the pilot hole may be reamed to a larger size using any suitable reaming tool. The reaming tool may be sized specifically for the type and/or number of delivery lines to be placed in the optimized underground crossing. The reamed hole may then be swabbed out to clean the selected path. While swabbing, or shortly thereafter, a pipe may be pulled through the selected path. The pipe may be the delivery line 104 for the optimized underground crossing 102. Further, the pipe may be a conduit for placement of the delivery line(s). The worksite 100 may then be commissioned and cleaned up.

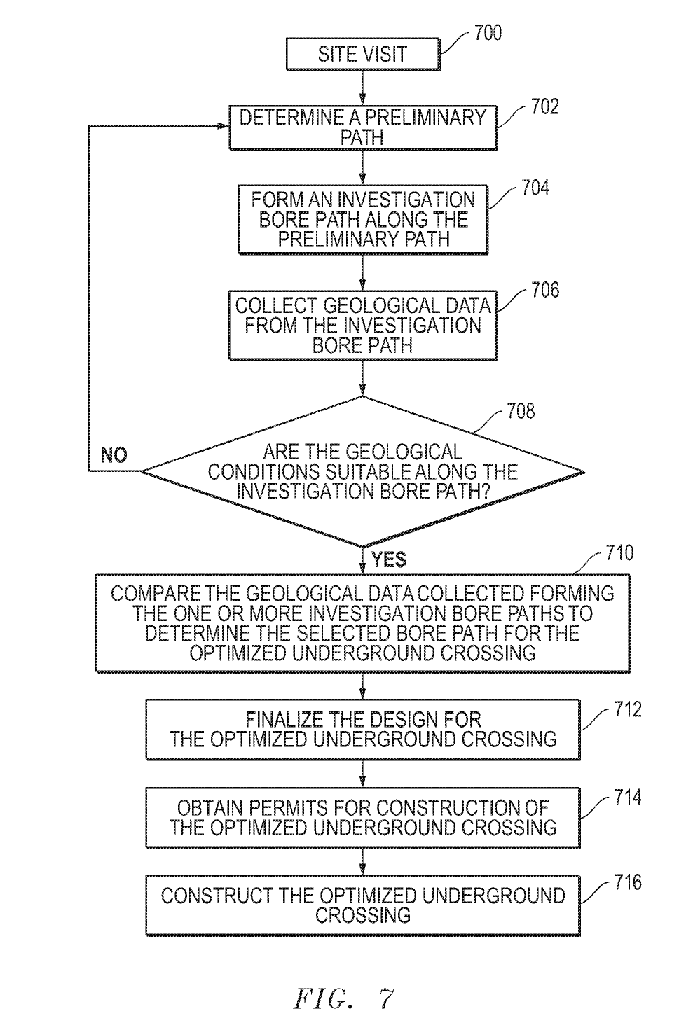

FIG. 7 is a flowchart depicting a method of forming the optimized underground crossing 102 (as shown in FIG. 1). The optimized underground crossing 102 may be formed along a bore path through the earth. The optimized underground crossing may have any number of delivery lines through the crossing. The flow begins at block 700, wherein a site visit is performed at a proposed location for the optimized underground crossing. The site visit may include, but is not limited to, a land survey. The flow continues at block 702, wherein a preliminary path is determined for the optimized underground crossing. In this phase, a preliminary design and/or preliminary geological appraisal based on the site visit may be performed. The flow continues at block 704, wherein an investigation bore path is formed along the preliminary path. The flow continues at block 706, wherein geological data is collected from the investigation bore path. The flow continues at block 708, wherein it is determined if the geological conditions are suitable for the optimized underground crossing 102 along the investigation bore path 206. If the geological conditions are not suitable, the flow returns to block 702 wherein another preliminary path is determined. If the geological conditions are suitable the flow continues at block 710, wherein the collected geological data from forming the one or more investigation bore paths is used to determine the selected bore path for the optimized underground crossing 102. The flow continues at block 712, wherein the design for the optimized underground crossing is finalized. The schedule, the cost and the scope of work may be determined during the finalizing of the design of the optimized underground crossing. Because the scope of work is based on the collected geological data from the one or more investigation bore paths, the cost and schedule may be very accurate. The flow continues at block 714, wherein permits may be obtained for the construction of the optimized underground crossing. The permits may be based on the scope of work determined in the finalized design phase. The flow continues at block 716, wherein the optimized underground crossing is constructed along the selected bore path. The optimized underground crossing may be constructed in any suitable manner including those described herein.

While the embodiments are described with reference to various implementations and exploitations, it will be understood that these embodiments are illustrative and that the scope of the inventive subject matter is not limited to them. Many variations, modifications, additions, and improvements are possible. For example, the techniques used herein may be applied in multiple underground crossing applications for multiple delivery lines and/or transportation lines.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A system for forming a bore path through the earth, wherein the bore path is for an underground crossing having of one or more delivery lines comprising:
a drilling rig;
a drilling tool conveyed into the earth by the drilling rig for forming an investigation bore path in the earth prior to forming the bore path; and
a data collection system for collecting geological information regarding the investigation bore path prior to constructing the bore path wherein the collected geological information from the investigation bore path is used to determine a selected path for the bore path.

2. The system of claim 1, wherein the data collection system further comprises a wireline logging tool.

3. The system of claim 1, wherein the data collection system further comprises a downhole survey tool.

4. The system of claim 1, wherein the data collection system further comprises a downhole sensor for measuring annular pressure.

5. The system of claim 1, wherein the data collection system further comprises a sensor for determining one or more geological parameters of the earth surrounding the investigation bore path.

6. The system of claim 1, wherein the data collection system further comprises a mud mixing system configured to separate cuttings from the investigation bore path for analysis by a geologist.

7. A method for forming an underground crossing through the earth at a worksite, wherein the underground crossing allows one or more delivery lines to pass through the earth, the method comprising;
determining a preliminary path of the underground crossing;
forming an investigation bore path along the preliminary path;
collecting geological data along the investigation bore path;
determining a selected bore path for the underground crossing;
finalizing the design of the underground crossing based on the collected geological data; and
forming the underground crossing along the selected bore path.

8. The method of claim 7, further comprising forming a second investigation bore path along a second preliminary path and collecting geological data along the second investigation bore path.

9. The method of claim 8, further comprising comparing the collected geological data from the investigation bore path and the second investigation bore path to determine the selected bore path.

10. The method of claim 7, wherein determining the preliminary path further comprises a site visit of the worksite.

11. The method of claim 10, wherein determining the preliminary path further comprises a land survey of the worksite and performing a preliminary design.

12. The method of claim 7, further comprising forming a log from the collected geological data.

13. The method of claim 12, wherein the log comprises a rate of penetration log.

14. The method of claim 12, wherein the log comprises a pressure log.

15. The method of claim 7, further comprising determining the location of one or more subsurface hazards during the forming of the investigation bore path.

16. The method of claim 15, further comprising avoiding the one or more subsurface hazards when forming the underground crossing.

17. A method for optimizing a design of an underground crossing through the earth at a worksite, wherein the underground crossing allows one or more delivery lines to pass through the earth, the method comprising;
forming an investigation bore path along a preliminary path of the underground crossing;
collecting geological data along the investigation bore path;
determining a selected bore path for the underground crossing;
finalizing a design for the construction of the underground crossing, wherein the finalized design is based upon the collected geological data; and
obtaining one or more permits for the underground crossing based on the finalized design.

18. The method of claim 17, wherein finalizing the design further comprises preparing a scope of work.

19. The method of claim 17, wherein finalizing the design further comprises estimating a cost of the construction project.

20. The method of claim 17, wherein finalizing the design further comprises estimating a schedule of the construction project.
